(19) United States
(12) Patent Application Publication
(10) Pub. No.: US 2013/0008768 A1
(43) Pub. Date: Jan. 10, 2013

(54) SWITCH

(75) Inventors: Takashi Nose, Kasugai-shi (JP); Manabu Sakai, Kasugai-shi (JP); Yasuhide Tanaka, Kasugai-shi (JP); Akira Goto, Kasugai-shi (JP); Hidetoshi Yoshikawa, Kasugai-shi (JP); Takuya Nishioka, Kasugai-shi (JP); Shiho Nakano, Kuwana-shi (JP)

(73) Assignee: OMRON AUTOMOTIVE ELECTRONICS CO., LTD., Aichi (JP)

(21) Appl. No.: 13/542,729

(22) Filed: Jul. 6, 2012

(30) Foreign Application Priority Data
Jul. 6, 2011 (JP) 2011-150210

(51) Int. Cl. H01H 1/26

(52) U.S. Cl. 200/535

(57) ABSTRACT

A switch has a first leaf spring having a first contact, the first contact being formed in a V shape and including two inclined surfaces, a second leaf spring having a second contact facing the first contact, the second contact being formed in a convex shape and including vertexes facing the inclined surfaces, respectively; and a pressing unit that presses the first leaf spring or the second leaf spring. When the pressing unit presses the first leaf spring or the second leaf spring, the inclined surface on a first side of the first contact and the vertex on a first side of the second contact come in contact with each other, and the vertex on the first side of the second contact slides on the inclined surface on the first side of the first contact.

### BACKGROUND OF THE INVENTION

1. Technical Field

The present invention relates to a switch with contacts provided in two leaf springs.

2. Related Art

As a switch with contacts provided in two leaf springs, for example, there is a known switch disclosed in Japanese Unexamined Patent Publication No. 2002-175735. In this switch, contacts (contact portions) to come in contact with each other are provided at free ends of two leaf springs (electric contacts). Each contact includes an inclined surface and a vertical surface. When a first leaf spring is pressed in a state in which the inclined surface of the first leaf spring and the inclined surface of a second leaf spring are in contact with each other, a contact of the first leaf spring is displaced in a pressing direction, and as a result the inclined surfaces of both the leaf springs come to slide. As a result, a contact of the second leaf spring is displaced in a direction which intersects the pressing direction, and finally the vertical surfaces of both the leaf springs come to slide on each other.

In such a switch, if dust or the like adheres to the contact, the dust becomes present between flat surfaces of the contacts at the time when the flat surfaces of the contacts slide on each other, and as a result electrical conduction between the contacts is impaired. Moreover, an increase in the range of movement of the leaf spring directly leads to an increase in the size of the switch.

### SUMMARY

One or more embodiments of the present invention provides a switch with contacts provided in two leaf springs, the switch being capable of securing conduction between contacts even with dust adhering thereto, and decreasing the range of movement of a leaf spring.

In accordance with one or more embodiments of the present invention, there is provided a switch including a first leaf spring with a first contact thereon and a second leaf spring with a second contact facing the first contact, in which the first contact is formed in a V shape and has two inclined surfaces. The second contact is formed in a convex shape and has vertexes facing the inclined surfaces, respectively. Moreover, the switch may further include a pressing unit which presses the first leaf spring or the second leaf spring. As the pressing unit presses the first leaf spring or the second leaf spring, the inclined surface on one side of the first contact and the vertex on the one side of the second contact come in contact with each other, then the vertex on the one side of the second contact slides on the inclined surface on the one side of the first contact, and, finally the inclined surface on the other side of the first contact and the vertex on the other side of the second contact also come in contact with each other.

Because of this structure, as the inclined surface on the one side of the first contact and the vertex on the one side of the second contact come in contact with each other and then slide on each other, the inclined surface on the other side of the first contact and the vertex on the other side of the second contact also come into contact with each other. Therefore, even if dust or the like adheres to the contacts, the dust is removed from between the inclined surfaces and the vertexes at the time when the inclined surface and the vertex on the one side of both of the contacts slide on each other, so that the conduction between the contacts can be secured. Moreover, the first contact or the second contact may be slightly displaced so that the inclined surface on the one side of one contact and the vertex on the one side of the other contact slide on each other and as a result the inclined surface on the other side of one contact and the vertex on the other side of the other contact come in contact with each other. Accordingly, a movement range of the leaf spring can be decreased.

Moreover, in the switch in accordance with the present aspect, central axes of the first contact and the second contact which are in parallel with a the pressing direction of a pressing unit may be shifted from each other in a direction perpendicular to the pressing direction.

Moreover, in the switch in accordance with the present aspect, the first contact or the second contact may be displaced in the direction perpendicular to the pressing direction of the pressing unit while the inclined surface on one side of one contact and the vertex on one side of the other contact slide on each other.

In the switch in accordance with the present aspect, the first leaf spring or the second leaf spring may be provided with a vertical extension, of which a flat surface faces perpendicularly to a direction of displacement of the first contact or the second contact and which extends perpendicularly to the direction of displacement and to the pressing direction of the pressing unit.

Moreover, in the switch in accordance with the present aspect, the first contact may be disposed such that a vertex thereof being present at a border line between the two inclined surfaces is disposed in an upward direction, and the second contact may be disposed in a downward direction of the first contact so as to protrude in an upward direction.

In addition, in the switch in accordance with the present aspect, the first contact may be disposed such that a vertex thereof being present at a border line between the two inclined surfaces is disposed in a downward direction, and the second contact may be disposed above the first contact so as to protrude in a downward direction.

According to one or more embodiments of the present invention, in a switch in which contacts are provided in two leaf springs, electrical conduction can be secured even with dust or the like adhering thereto, and a range of movement of the leaf springs can be reduced.

### BRIEF DESCRIPTION OF THE DRAWINGS

FIG. 1 is a perspective view of a switch unit equipped with a switch according to one embodiment of the present invention;

FIG. 2 is a cross-sectional view of the switch unit;

FIG. 3 is a perspective view of the switch viewed from above;

FIG. 4 is a perspective view of the switch viewed from below;

FIGS. 5A to 5C are side views of the switch;

FIGS. 6A to 6C are enlarged views of a first contact and a second contact of the switch;

FIG. 7 is a perspective view of a first leaf spring of the switch;

FIG. 8 is a perspective view of a second leaf spring of the switch;

FIGS. 9A to 9C are enlarged views of a switch according to another embodiment;

FIGS. 10A to 10C are enlarged views of a switch according to a further embodiment; and

FIGS. 11A to 11C are enlarged views of a switch according to yet another embodiment.

### DETAILED DESCRIPTION

Hereafter, embodiments of the present invention will be described with reference to the accompanying drawings. Throughout the drawings, the same or corresponding components are denoted by the same reference letters. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

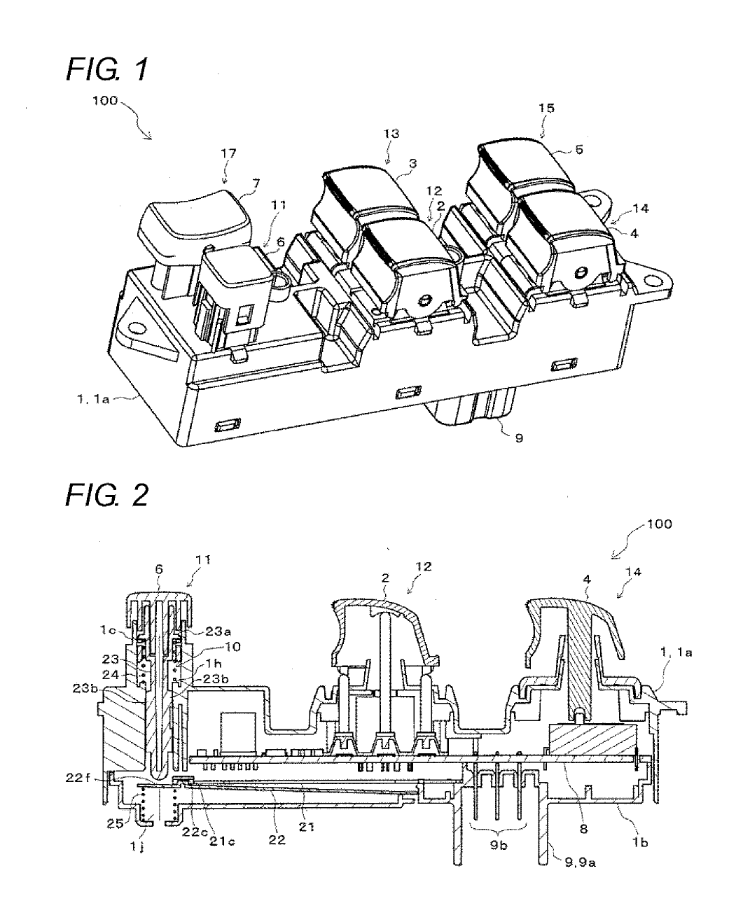

A switch unit 100 illustrated in FIG. 1 is a switch module for power window. The switch unit 100 is attached to an armrest installed on a door near the driver's seat in a vehicle.

The switch 11 according to one embodiment of the present invention is provided in the switch unit 100. The switch 11 is a window lock switch to lock glass windows of respective seats in the vehicle so that the glass windows cannot be opened and closed, or to release the lock of the glass windows.

Besides this, the switch unit 100 is further equipped with switches 12 to 15 and 17. The switches 12 to 15 are window operation switches to open and close the glass windows of the respective seats in the vehicle. The switch 17 is a door lock switch to lock doors of respective seats in the vehicle so that the doors cannot be opened, or to release the lock.

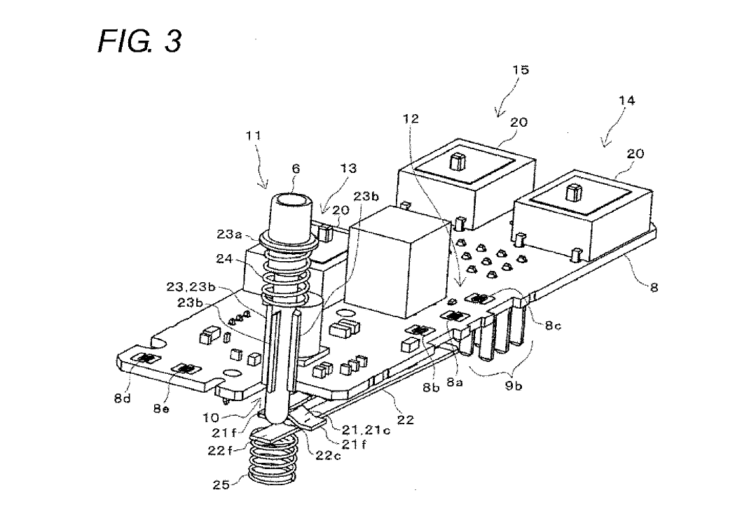

As illustrated in FIG. 2, a case 1 is assembled such that an upper member 1a and a lower member 1b are fitted into each other. As illustrated in FIG. 1, operation knobs 2 to 5 of the respective switches 12 to 15, an operation button 7 of the switch 17, and an operation button 6 of the switch 11 are provided on the case 1. A plurality of operation knobs 2 to 5 are arranged at intervals in the longitudinal direction L. The operation buttons 6 and 7 are disposed in front of the operation knobs 2 to 5 on the case 1.

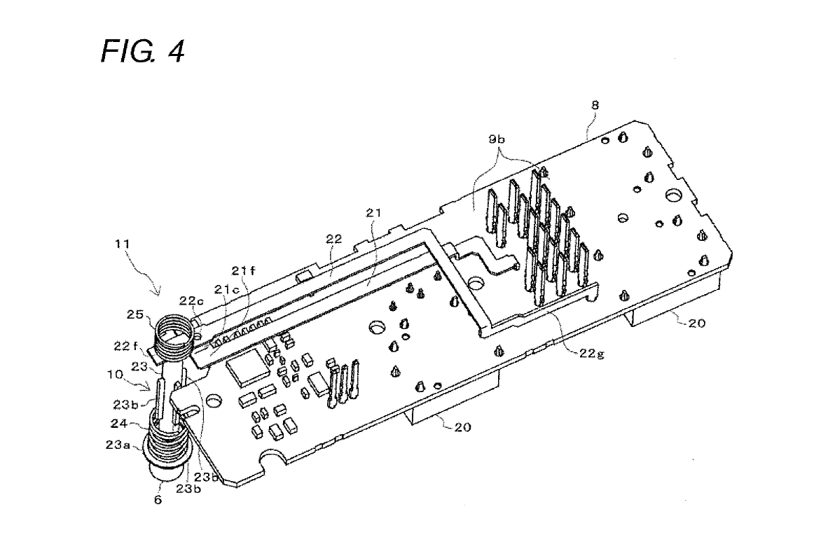

Components other than operation members 2 to 7 of the respective switches 11 to 15 and 17, and a substrate 8 are provided in the case 1 (See FIGS. 2 and 3). FIG. 2 illustrates only the switches 11, 12, and 14. FIG. 3 illustrates only slide switches 20 provided in the switch 11 and the switches 13 to 15, fixed contacts 8a, 8b, and 8c provided in the switch 12, and fixed contacts 8d and 8e provided in the switch 17.

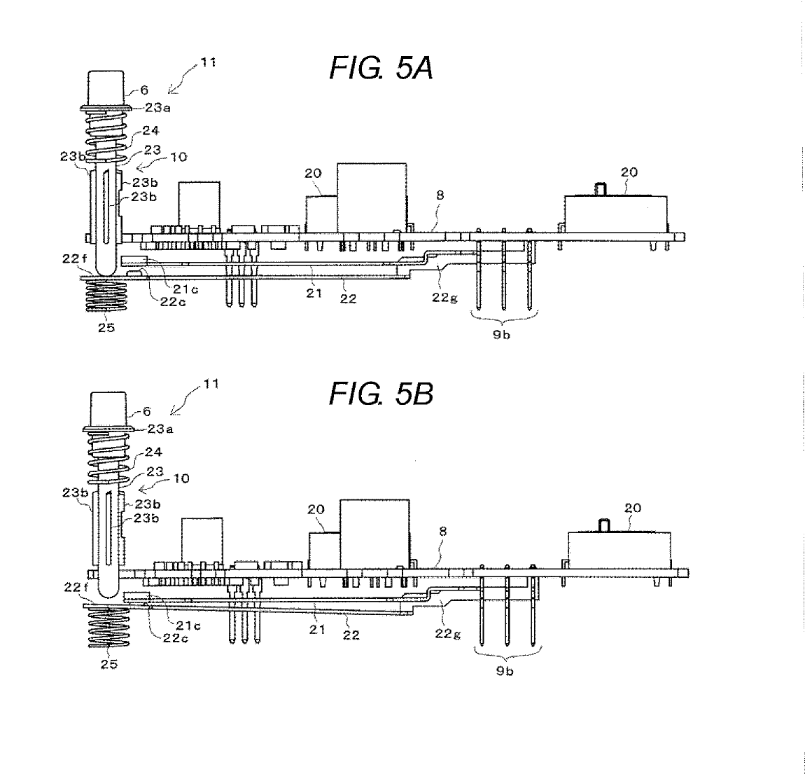

The substrate 8 is sandwiched and supported between the upper member 1a and the lower member 1b of the case 1 from the upward and downward directions thereof. As illustrated in FIGS. 3 and 4, the slide switches 20, the fixed contacts 8a, 8b, 8c, 8d, and 8e, other electronic parts, wirings, and circuits are mounted on the substrate 8.

A connector 9 including a terminal 9b is provided under the case 1 as illustrated in FIG. 2. A housing 9a of the connector 9 is integrally formed with the lower member 1b of the case 1. An end of the terminal 9b of the connector 9 protrudes from the lower member 1b and the other end is connected to the substrate 8. Specifically, as illustrated in FIGS. 2 to 4, the other end of the terminal 9b of the connector 9 is connected to the substrate 8 at a portion of the substrate 8 where a relatively large space is provided, especially, between the switches 12 and 13 on the front side and the switches 14 and 15 on the rear side.

A cable to connect the connector 9 to a controller or the like included in the vehicle is inserted into the connector 9 (not illustrated). Since the cable is inserted into the connector 9, exchange of a signal between the switch unit 100 and the controller and supply of power to the switch unit 100 are possible.

The switch 11 includes the operation button 6, a handler 23, coil springs 24 and 25, a first leaf spring 21, a second leaf spring 22, and a push lock mechanism 10. The handler 23 passes through a cylinder portion 1c provided in the upper member 1a of the case 1. The operation button 6 is installed at an upper end of the handler 23. The coil spring 24 is installed between a brim portion 23a of the handler 23 and a step portion 1h in the cylinder portion 1c. The coil spring 24 presses up the brim portion 23a of the handler 23.

Four ribs 23b are installed on an outside circumferential surface of the handler 23 at equal intervals under the coil spring 24 (See FIGS. 3 and 4). The ribs 23b extend in a direction of the axis of the handler 23. Four lock projections are installed on an inside circumferential surface of the cylinder portion 1c at equal intervals (not illustrated). The coil spring 24, the handler 23, the ribs 23b, the cylinder portion 1c, and the lock projections constitute the push lock mechanism 10.

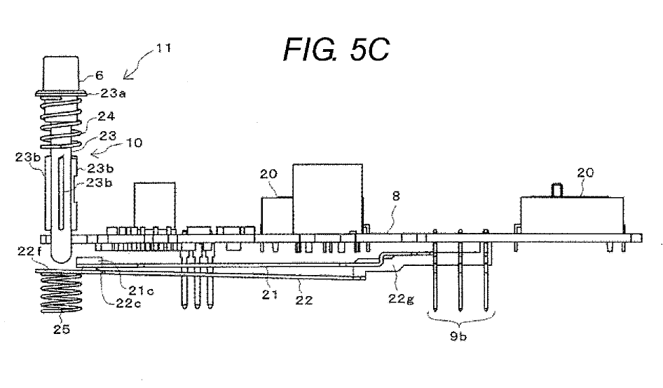

As for the push lock mechanism 10, in the state illustrated in FIG. 2 and FIG. 5C, the ribs 23b of the handler 23 are separated from the lock projections of the cylinder portion 1c, so that the handler 23 and the operation button 6 are pushed up by the spring 24 and stay at an ascending position. When the operation button 6 is pressed down, the handler 23 descends, and as a result the ribs 23b are latched to the lock projections, and the handler 23 and the operation button 6 are locked at a descending position as illustrated in FIG. 5A. When the operation button 6 is pressed down again, the handler 23 descends and the ribs 23b come off from the lock projections. As a result, the handler 23 and the operation button 6 are pushed up by the coil spring 24 and thus return to the ascending position as illustrated FIG. 2 and FIG. 5C.

The first leaf spring 21, the second leaf spring 22, and the coil spring 25 are disposed on a rear side of the substrate 8 which is opposite the front side on which operation members 2 to 7 are provided as illustrated in FIG. 2 to 5. Each of the leaf springs 21 and 22 is formed of a metal (for example, copper) that is an electroconductive material.

The first contact 21c is installed at an end of the first leaf spring 21. The second contact 22c is installed at an end of the second leaf spring 22. The first contact 21c and the second contact 22c face to each other.

The other ends of the respective leaf springs 21 and 22 are connected to the substrate 8 at a position near the terminal 9b of the connector 9 as illustrated in FIG. 4. That is, the other ends of the respective leaf springs 21 and 22 are connected to the substrate 8 at a position between the switches 12 and 13 on the front side and the switches 14 and 15 on the rear side as illustrated in FIGS. 2 to 4, in which the substrate 8 has a relatively large space around that position.

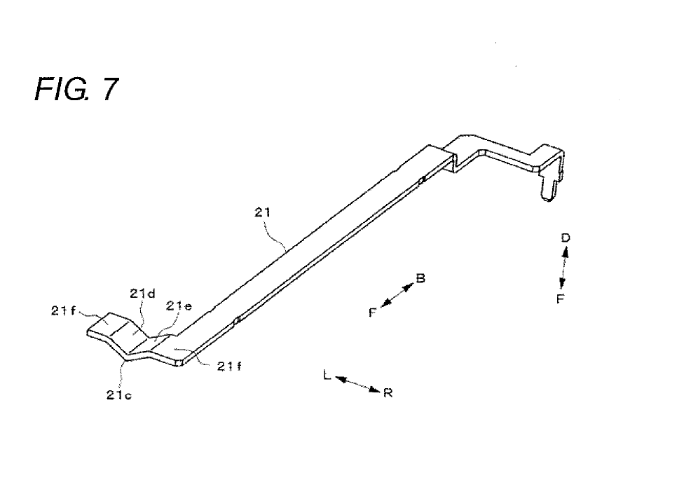

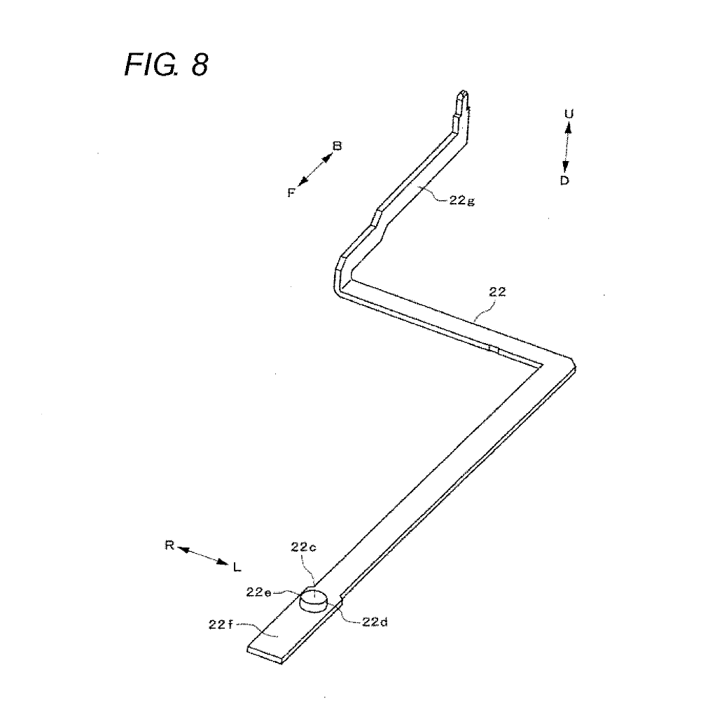

The first leaf spring 21 is processed to bend as illustrated in FIG. 7. The first contact 21c of the first leaf spring 21 is formed in a V shape and has two inclined surfaces 21d and 21e on an inner side of the V shape. The second leaf spring 22 is processed to bend as illustrated in FIG. 8. The second contact 22c of the second leaf spring 22 is formed in a convex shape.

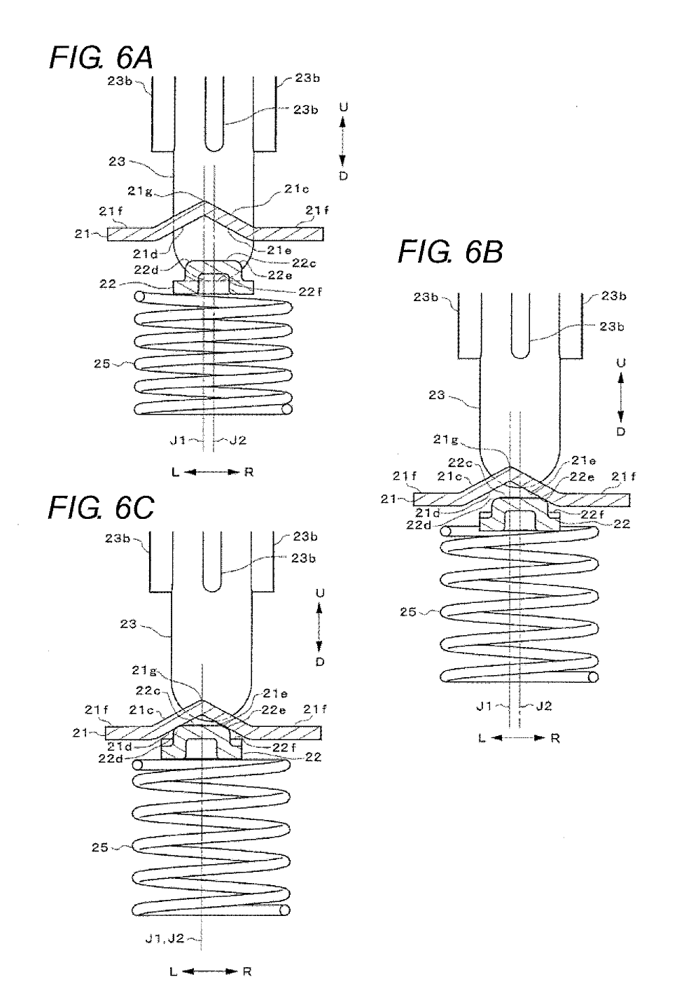

FIGS. 6A to 6C are enlarged views illustrating a main portion of the switch 11 (illustrating the contacts 21c and 22c of the leaf springs 21 and 22 and the surrounding portions). The first contact 21c of the first leaf spring 21 is disposed such that a vertex 21g thereof being present at a border line between two inclined surfaces 21d and 21e is disposed in an upward direction U. Horizontal portions 21f provided at both sides of the first contact 21c are supported from the underside thereof by support projections (not illustrated) provided in the lower member 1b of the case 1.

The second contact 22c of the second leaf spring 22 is disposed in a downward direction D of the first contact 21c, while protruding in an upward direction U. The second contact 22c has a vertex 22d on an L side which faces the inclined surface 21d of the first contact 21c and a vertex 22e on an R side R thereof which faces the inclined surface 21e.

A pressed portion 22f is provided near the second contact 22c of the second leaf spring 22 (See FIGS. 2 to 5 and FIG. 8). The handler 23 presses the pressed portion 22f of the second leaf spring 22 in the downward direction D. The coil spring 25 is fitted into a concave portion 1j formed in the lower member 1b of the case 1 as illustrated in FIG. 2. The coil spring 25 presses the pressed portion 22f of the second leaf spring 22 in the upward direction U. The coil spring 25 is an example of the “pressing unit” according to one or more embodiments of the present invention.

As illustrated in FIGS. 6A to 6C, central axes J1 and J2 of the first contact 21c and the second contact 22c which are in parallel with the pressing direction U or D of the coil spring 25 or the handler 23 are shifted from each other in a direction L or R perpendicular to the pressing direction U or D. Specifically, the central axis J2 of the second contact 22c is shifted from the central axis J1 of the first contact 21c in the direction R by a predetermined amount. Therefore, as described below, the second contact 22c is displaced in the direction L or R when the first contact 21c and the second contact 22c move to be closer to or be away from each other.

As illustrated in FIG. 8, the second leaf spring 22 includes a vertical extension 22g. The vertical extension 22g has a flat surface facing perpendicularly to the direction L or R which is the direction of displacement of the second contact 22c, and the vertical extension 22g extends in a direction F or B which is perpendicular to the pressing direction U or D of the handler 23 or the coil spring 25, and to the displacement direction L or R.

In the state illustrated in FIG. 5A, the operation button 6 and the handler 23 are locked at the descending position by the push lock mechanism 10. Therefore, as illustrated in FIG. 6A, the handler 23 presses the pressed portion 22f of the second leaf spring 22 in the downward direction D, and as a result the second contact 22c comes off from the first contact 21c. Moreover, the central axes J1 and J2 of the first contact 21c and the second contact 22c are displaced in the direction L or R which is perpendicular to the pressing direction D or U of the coil spring 25 and the handler 23.

When the operation button 6 is pressed down from that state and as a result the lock by the push lock mechanism 10 is released, the operation button 6 and the handler 24 are pushed up by the coil spring so as to return to the ascending position. In that case, the handler 23 comes off from the pressed portion 22f of the second leaf spring 22 as illustrated in FIG. 5B, and as a result the state in which the handler 23 presses the pressed portion 22f is canceled.

Moreover, since the coil spring 25 presses the pressed portion 22f of the second leaf spring 22 in the upward direction U, first of all, as illustrated in FIG. 6B, the vertex 22e on the R side of the second contact 22c of the second leaf spring 22 comes in contact with the inclined surface 21e on the R side of the first contact 21c of the first leaf spring 21 (first contact state). After that, the vertex 22e of the second contact 22c slides on the inclined surface 21e of the first contact 21c in the direction L, and at the same time the second contact 22c is displaced in the direction L which is perpendicular to the pressing direction U of the coil spring 25. Next, as illustrated in FIG. 6C, the vertex 22d on the L side of the second contact 22c comes in contact with the inclined surface 21d on the L side of the first contact 21c finally (second contact state). As a result, the sliding and the displacement of the second contact 22c are stopped, and the central axes J1 and J2 of the first contact 21c and the second contact 22c agree with each other. At this time, the operation button 6 and the handler 23 stay at the ascending position as illustrated in FIG. 5C.

In this embodiment, as described above, since the inclined surface 21e on the R side of the contact 21c and the vertex 22e on the R side of the contact 22c first come in contact with each other and then slide on each other, the inclined surface 21d and the vertex 22d on the L side also come in contact with each other. Therefore, even though dust or the like adheres to the contacts 21c and 22c, the dust is removed from between the inclined surface 21e and the vertex 22e when the inclined surface 21e and the vertex 22e on the R side of the contacts 21c and 22c slide on each other, the electrical conduction between the contacts 21c and 22c can be secured. Moreover, since only the second contact 22c may be slightly displaced in the direction U and the direction L by causing the inclined surface 21e on the R side of the contact 21c and the vertex 22e on the R side of the contact 22 to slide on each other so that the inclined surface 21d on the L side can come in contact with the vertex 22d, the range of movement of the second leaf spring 22 can be reduced. Moreover, since the first leaf spring 21 is not displaced, the range of movement of the first leaf spring 21 need not be considered. In addition, since two contact points exist after the contact 21c and the contact 22c have come in contact with each other at one point, the contact state can be stably maintained.

Moreover, in this embodiment, since the central axes J1 and J2 of the first contact 21c and the second contact 22c are shifted from each other in the direction L or R, the dust adhering to the contact 21c and the contact 22c is removed by causing the inclined surface 21e on the R side of the contact 21c and the vertex 22e on the R side of the contacts 22c to slide on each other, and as a result the conduction between the contact 21c and the contact 22c can be stabilized.

Moreover, in this embodiment, since the second contact 22c is displaced in the direction L while the inclined surface 21e on the R side of the contact 21c and the vertex 22e on the R side of the contact 22c are sliding on each other, the inclined surface 21e and the vertex 22e can smoothly slide on each other, and as a result the inclined surface 21d and the vertex 22d on the L side can surely come in contact with each other.

Moreover, in this embodiment, since the second leaf spring 22 is provided with the vertical extension 22g, the second contact 22c of the second leaf spring 22 can be easily displaced in the direction L or R which is perpendicular to the pressing direction U.

In addition, in this embodiment, the first contact 21c is disposed such that the vertex 21g thereof is disposed in the upward direction U, and the second contact 22c is disposed in the downward direction of the first contact 21c, protruding in the upward direction. Therefore, the inclined surfaces 21d and 21e which are formed at the underside of the first contact 21c receive the second contact 22c formed in a convex shape, so that the contact state of the contact 21c and the contact 22c is more stably maintained. Moreover, it is difficult for the dust or the like to adhere to the inclined surfaces 21d and 21e of the first contact 21c or to the second contact 22c which is covered by the inclined surfaces 21d and 21e. In addition, even though the dust or the like adheres to the contacts 21c and 22c, it is possible to make the dust fall off from between the contacts 21c and 22c when the contacts 21c and the 22c slide on each other,

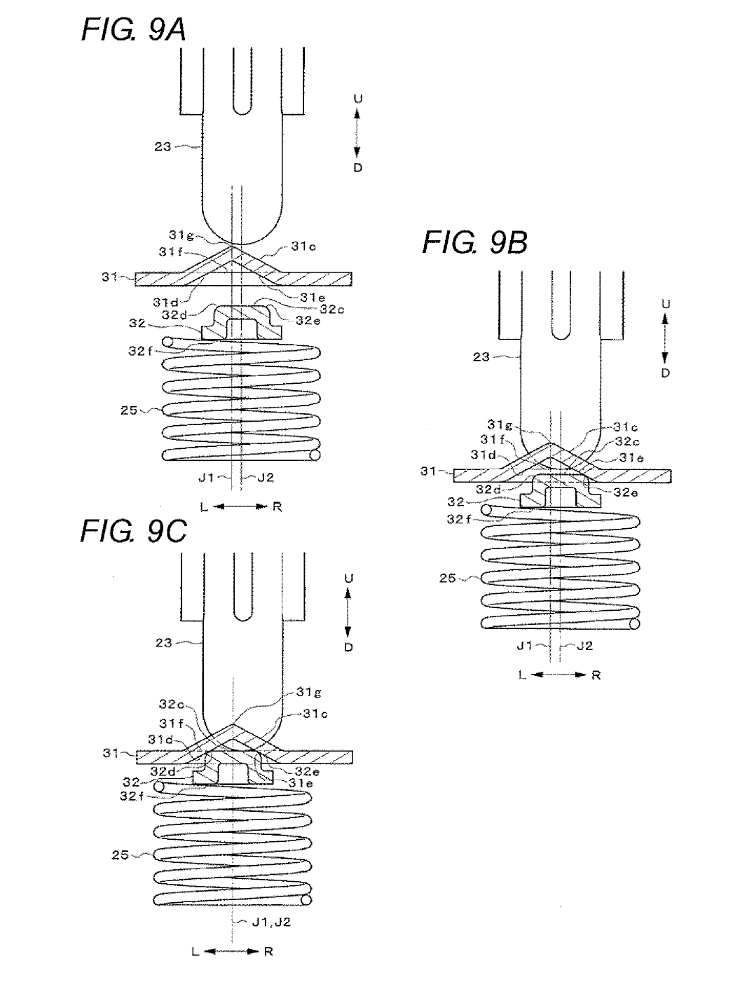

The present invention can adopt various embodiments besides the above-described embodiments. For example, the embodiment described above shows an example in which the second contact 22c comes in contact with the first contact 21c as the coil spring 25 presses the second leaf spring 22, but the present invention is not limited thereto. Besides of this, for example, as illustrated in FIGS. 9A to 9C, a first contact 31c may come in contact with a second contact 32c as a handler 23 presses a first leaf spring 31.

In the embodiment of FIGS. 9A to 9C, a coil spring 25 supports a horizontal portion 32f near the second contact 32c of the second leaf spring 32 from the underside. In a state where the contacts 31c and 32c are separated from each other as illustrated in FIGS. 9A to 9C, as the handler 23 presses a pressed portion 31f of the first leaf spring 31 in the downward direction D, first of all, as illustrated in FIG. 9B, an inclined surface 31e on an R side of the first contact 31c comes in contact with a vertex 32e on the R side of the second contact 32c. Thereafter, the inclined surface 31e and the vertex 32e slide on each other and at the same time the first contact 31c or the second contact 32c is displaced in a direction L or a direction R which is perpendicular to the pressing direction D. Next, as illustrated in FIG. 9C, an inclined surface 31d on an L side of the first contact 31c comes in contact with a vertex 32d on the L side of the second contact 32c finally. The handler 23 is an example of a “pressing unit” according to one or more embodiments of the present invention.

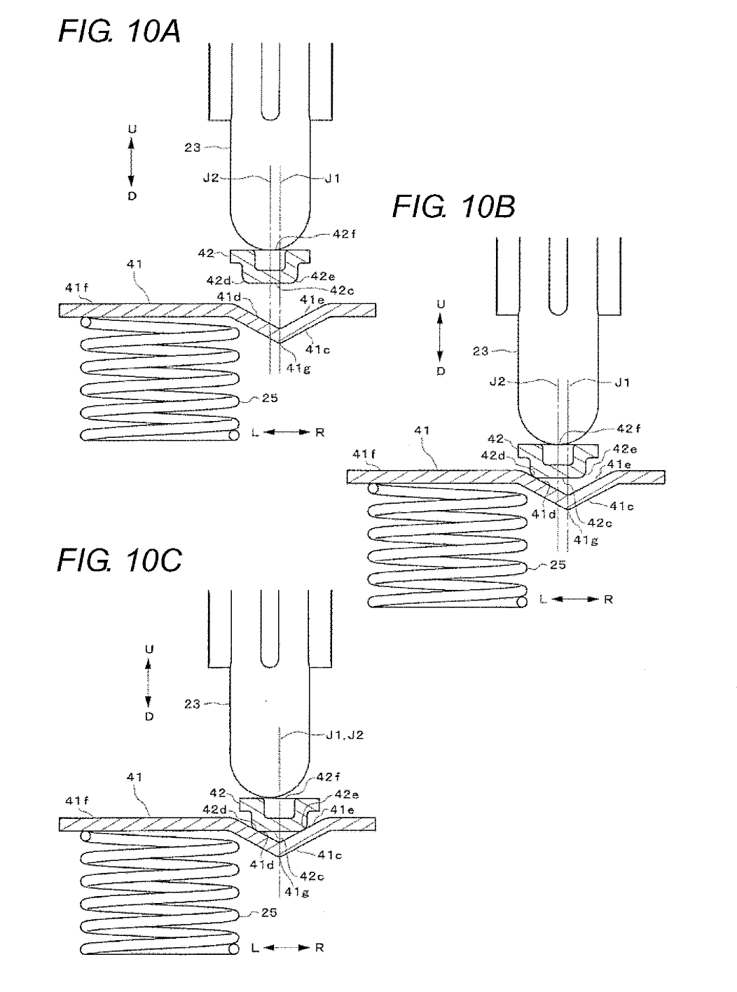

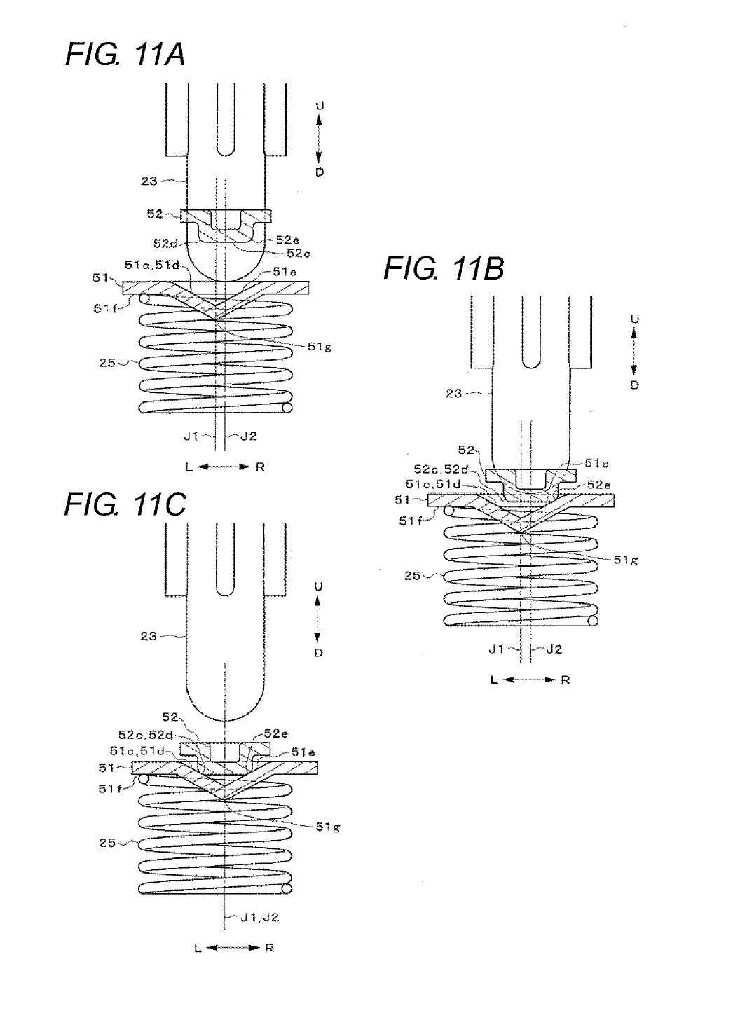

Moreover, the present embodiment shows an example in which the first contact 21c or 31c of the first leaf spring 21 or 31 is disposed above the second contact 22c or 32c of the second leaf spring 22 or 32 formed in a convex shape, and the vertex 21g or 31g is disposed in the upward direction U, but the present invention is not limited thereto. Besides of this, for example, as illustrated in FIGS. 10A to 10C and 11A to 11C, a second contact 42c or 52c of a second leaf springs 42 or 52 formed in a convex shape is disposed to protrude downward, a first contact 41c or 51c of a first leaf spring 41 or 51 is disposed in the downward direction of the second contact 42c or 52c such that its vertex portion 41g or 51g is directed in the downward direction U.

In the embodiment of FIGS. 10A to 10C, a coil spring 25 supports a horizontal portion 41f near the first contact 41c of the first leaf spring 41 from the underside. In a state illustrated in FIG. 10A in which the contacts 41c and 42c are separated from each other, a handler 23 presses a pressed portion 42f of the second leaf spring 42 in the downward direction D. As a result, as illustrated in FIG. 10B, a vertex 42d on an L side of the second contact 42c comes in contact with an inclined surface 41d on the L side of the first contact 41c. Next, the vertex 42d and the inclined surface 41d slide on each other and at the same time the first contact 41c or the second contact 42c is displaced in the direction L or the direction R which is perpendicular to the pressing direction D. Next, as illustrated in FIG. 10C, a vertex 42e on an R side of the second contact 42c comes into contact with an inclined surface 41e on the R side of the first contact 41c.

In the embodiment illustrated in FIGS. 11A to 11C, when contacts 51c and 52c are separated as illustrated in FIG. 11A, a handler 23 is unlocked by a push lock mechanism 10. As a result, the handler 23 returns to an ascending position, and a pressed portion 51f of the first leaf spring 51 cannot be pressed in a downward direction D by the handler 23. Therefore, as the pressed portion 51f is pressed in the upward direction U by the coil spring 25, as illustrated in FIG. 11B, an inclined surface 51e on an R side of the first contact 51c comes in contact with a vertex 52e on the R side of the second contact 52c. After that, the inclined surface 51e and the vertex 52e slide on each other and at the same time the first contact 51c or the second contact 52c is displaced in a direction L or a direction R which is perpendicular to the pressing direction. As illustrated in FIG. 11C, an inclined surface 51d on an L side of the first contact 51c comes in contact with a vertex 52d on the L side of the second contact 52c finally.

The embodiment shown in FIGS. 6A to 6C is an example in which the second contact 22c of the second leaf spring 22 is displaced in a direction perpendicular to the pressing direction, but the present invention is not limited thereto. The object that is displaced in a direction perpendicular to the pressing direction may be the first contact, the second contact, or both. Moreover, the object may be a contact provided in the leaf spring which is pressed by the pressing unit, or may be a contact provided in the leaf spring which is not pressed.

Moreover, the embodiment of FIG. 8 shows an example in which the second leaf spring 22 provided with the second contact 22c formed in a convex shape includes a vertical extension 22g, but the present invention is not limited thereto. The vertical extension may be provided in the first leaf spring having the V-shaped first contact. The vertical extension may be provided in the leaf spring which is displaced in a direction perpendicular to the pressing direction by the pressing unit.

In addition, the above embodiments shows an example of a window lock switch provided in a switch unit 100 for power window. However, one or more embodiments of the present invention may be applied to various switches for other uses.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switch comprising:
a first leaf spring comprising a first contact, the first contact being formed in a V shape and including two inclined surfaces;
a second leaf spring comprising a second contact facing the first contact, the second contact being formed in a convex shape and including vertexes facing the inclined surfaces, respectively; and
a pressing unit that presses the first leaf spring or the second leaf spring,
wherein, when the pressing unit presses the first leaf spring or the second leaf spring, the inclined surface on a first side of the first contact and the vertex on a first side of the second contact come in contact with each other, the vertex on the first side of the second contact slides on the inclined surface on the first side of the first contact, and finally the inclined surface on a second side of the first contact and the vertex on a second side of the second contact come in contact with each other.

2. The switch according to claim 1, wherein central axes of the first contact and the second contact that are in parallel with a pressing direction are shifted from each other in a direction that is perpendicular to the pressing direction.

3. The switch according to claim 1, wherein, on first side of the first contact and the second contact, while the inclined surface slides on the corresponding vertex, the first contact or the second contact is displaced in a direction perpendicular to the pressing direction.

4. The switch according to claim 3, wherein the first leaf spring or the second leaf spring is provided with a vertical extension that includes a flat surface facing perpendicularly to a direction in which the first contact or the second contact is displaced, the vertical extension extending in a direction perpendicular to the pressing direction, and to the direction in which the first contact or the second contact is displaced.

5. The switch according to any one of claim 1,
wherein the first contact is disposed such that a vertex portion thereof present at a boundary line between the two inclined surfaces is disposed in an upward direction, and
wherein the second contact is disposed in a downward direction of the first contact so as to protrude in an upward direction.

6. The switch according to any one of claim 1,
wherein the first contact is disposed such that a vertex thereof being present at a border line between the two inclined surfaces is disposed in a downward direction, and
wherein the second contact is disposed in an upward direction of the first contact so as to protrude in a downward direction.

7. The switch according to claim 2, wherein, on first side of the first contact and the second contact, while the inclined surface slides on the corresponding vertex, the first contact or the second contact is displaced in a direction perpendicular to the pressing direction.

8. The switch according to claim 7, wherein the first leaf spring or the second leaf spring is provided with a vertical extension that includes a flat surface facing perpendicularly to a direction in which the first contact or the second contact is displaced, the vertical extension extending in a direction perpendicular to the pressing direction, and to the direction in which the first contact or the second contact is displaced.

9. The switch according to claim 2,
wherein the first contact is disposed such that a vertex portion thereof present at a boundary line between the two inclined surfaces is disposed in an upward direction, and
wherein the second contact is disposed in a downward direction of the first contact so as to protrude in an upward direction.

10. The switch according to claim 3,
wherein the first contact is disposed such that a vertex portion thereof present at a boundary line between the two inclined surfaces is disposed in an upward direction, and
wherein the second contact is disposed in a downward direction of the first contact so as to protrude in an upward direction.

11. The switch according to claim 4,
wherein the first contact is disposed such that a vertex portion thereof present at a boundary line between the two inclined surfaces is disposed in an upward direction, and
wherein the second contact is disposed in a downward direction of the first contact so as to protrude in an upward direction.

12. The switch according to claim 7,
wherein the first contact is disposed such that a vertex portion thereof present at a boundary line between the two inclined surfaces is disposed in an upward direction, and
wherein the second contact is disposed in a downward direction of the first contact so as to protrude in an upward direction.

13. The switch according to claim 8,
wherein the first contact is disposed such that a vertex portion thereof present at a boundary line between the two inclined surfaces is disposed in an upward direction, and
wherein the second contact is disposed in a downward direction of the first contact so as to protrude in an upward direction.

14. The switch according to claim 2,
wherein the first contact is disposed such that a vertex thereof present at a border line between the two inclined surfaces is disposed in a downward direction, and
wherein the second contact is disposed in an upward direction of the first contact so as to protrude in a downward direction.

15. The switch according to claim 3,
wherein the first contact is disposed such that a vertex thereof present at a border line between the two inclined surfaces is disposed in a downward direction, and
wherein the second contact is disposed in an upward direction of the first contact so as to protrude in a downward direction.

16. The switch according to claim 4,
wherein the first contact is disposed such that a vertex thereof present at a border line between the two inclined surfaces is disposed in a downward direction, and
wherein the second contact is disposed in an upward direction of the first contact so as to protrude in a downward direction.

17. The switch according to claim 7,
wherein the first contact is disposed such that a vertex thereof present at a border line between the two inclined surfaces is disposed in a downward direction, and
wherein the second contact is disposed in an upward direction of the first contact so as to protrude in a downward direction.

18. The switch according to claim 8,
wherein the first contact is disposed such that a vertex thereof present at a border line between the two inclined surfaces is disposed in a downward direction, and
wherein the second contact is disposed in an upward direction of the first contact so as to protrude in a downward direction.
